(19) United States
(12) Patent Application Publication
(10) Pub. No.: US 2005/0175493 A1
(43) Pub. Date: Aug. 11, 2005

(54) Rotary piston machines comprising a displaceable inner housing

(76) Inventor: Felix Arnold, Stuttgart (DE)

Correspondence Address: JORDAN AND HAMBURG LLP, 122 EAST 42ND STREET, SUITE 4000, NEW YORK, NY, 10168, US

(21) Appl. No.: 10/522,960

(22) PCT Filed: Aug. 4, 2003
(86) PCT No.: PCT/DE03/02632

(30) Foreign Application Priority Data
Aug. 2, 2002 (DE) 102 35 604.1

(51) Int. Cl. F03C 2/00; F16N 13/20

(52) U.S. Cl. 418/68; 418/112; 418/143; 418/195

(57) ABSTRACT

In a rotary piston machine with an inner housing and rotors, the axes of the rotors are disposed at an angle to one another in order to equalize manufacturing tolerances and to reduce gap losses of such machines.

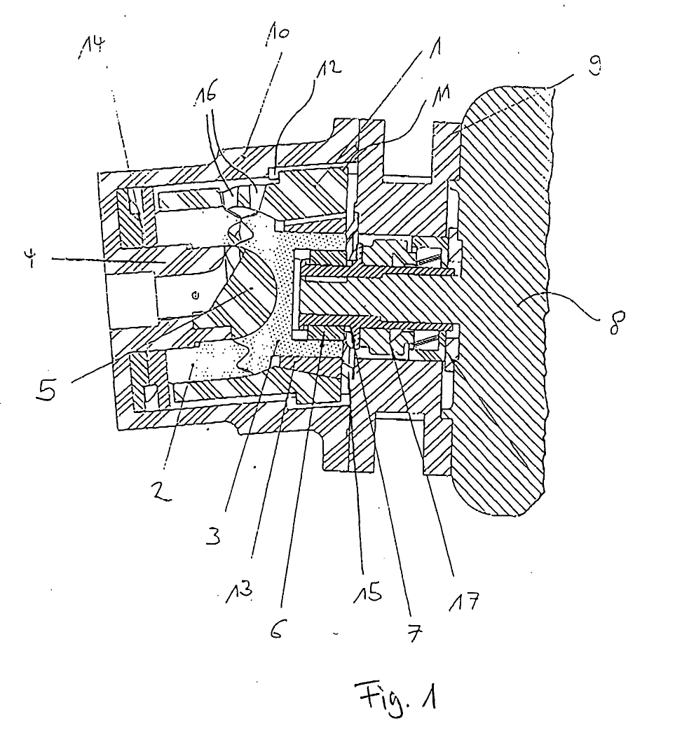

### BACKGROUND OF THE INVENTION

The invention relates to a rotary piston machine. The manufacture of rotary piston machines with power parts and shut-off parts with axes arranged at an angle to one another is known. For these, the rotors, at least one power part and one shut-off part occupy a spherical volume (DE 42 41 320 C2) or correspond to the volume of a spherical washer (198 37 729 A1).

However, such machines have the disadvantage that, especially when the overall dimensions become smaller, the gap losses between the regions in the interior of such machines, which are acted upon with different pressures and can be used as pumps or motors, increase and, due to methods such as the manufacture of components with lower tolerances, there is a disproportionate increase in the manufacturing costs for producing precise, meshing rotors and the associated housing, as a result of which the necessary expense for centering the rotors relative to one another increases exponentially and it is not possible to reduce these gap losses at economically justifiable costs.

### SUMMARY OF THE INVENTION

In comparison with the above, the inventive rotary piston machine has the advantage that, due to the arrangement of the inner housing, which can be shifted freely in the axial and radial directions, the inner housing is centered relative to the rotors, so that the dimensions of the gap between the components of the rotary piston machine, which can be moved relative to one another (power part, shut-off part, inner housing) and are arranged to form a seal, can be averaged, as a result of which the gap losses are reduced. This is achieved owing to the fact that the rotors, which have a spherical external shape and are centered, on the one hand, by a shaft, for example, the drive shaft of a motor (power part) that is flanged to the rotary piston machine and, on the other, the control head of the rotary piston machine (shut-off part), are surrounded by an inner housing with a spherical recess. With a cylindrical borehole, which goes over into the spherical recess, the inner housing freely movably takes up the rotor, the rotor being centered on the shank of the control head. The spherical recess is to accommodate the one rotor, which is disposed on shank and engages the other rotor, seated on the shank of the control head, at an axial angle. An opening in the spherical part of the inner housing permits the shaft, as well as the shank of the rotor (power part) fastened thereon, to be passed through. In addition, the inner housing is prevented from backing away from the control head, for example, by a cone, which surrounds the shank of the rotor rotating with the shaft, and prevented from rotating along by a protection against torsion, which can be shifted freely in the axial and radial directions, for example, by springs, which are disposed on the outside of the inner housing and engage recesses at the outer housing. Pressure equalization between the inside and the outside of the inner housing is produced through openings over a portion of the periphery at the inner housing which, depending on the type of operation, function as an inlet or an outlet of the conveying or driving fluid, so that the pressure between the inner housing and the housing is the same as that within the inner housing and that the pressure between the housing and the inner housing is higher than the static pressure in the gap between the outer circumferential surface of the rotors and of the inner surface of the inner housing during developing flow through the gap, so that, by these means, an additional sealing action is achieved, in that the inner housing is pressed all around on the rotors by the resulting pressure forces.

In accordance with a further advantageous development of the invention, the rotors and the inner housing surrounding the rotors can be pressed against one another in the axial direction, for example over an adjusting ring and a spring lock washer, so that the amount of fluid flowing through the gaps between the individual chambers formed by the rotors and between the rotor, lying in the spherical recess, and the inner housing, can additionally be reduced.

Further advantageous developments of the invention can be inferred from the following description of an example, the drawing and the claims.

An example of the invention is shown in the drawing and explained in greater detail in the following.

### BRIEF DESCRIPTION OF THE DRAWING

Accompanying the specification is a single FIGURE illustrating a cross sectional view of a rotary piston machine according to one embodiment of the invention.

### DETAILED DESCRIPTION OF THE INVENTION

The rotors of a rotary piston machine, the shut-off part 2 and the power part 3, engage one another at an axial angle, so that chambers are formed between the shut-off part 2 and the power part 3. The chambers have volumes variable over the angle of rotation for conveying fluids or gases.

With a borehole accommodating the shank 4 of the control head 5, the shut-off part 2 is disposed rotatably about the longitudinal axis of the shank 4. On the side facing the shut-off part 2, the power part 3 has a central, spherical recess for accommodating the control head 5.

By means of an adjusting spring 6 and a shaft extension 7, the shank of the power part 3 is fastened on the shaft of a motor 8. The housing 10 is fastened to the motor 8 over a flange 9.

The two rotors (shut-off part 2 and power part 3), which are fixed in their position by the shank 4 of the control head 5 and the shaft of the motor 8, are surrounded by an inner housing 1. The inner housing 1 can be shifted in the axial and radial directions and has a central borehole. The central borehole of the inner housing 1 goes over into a spherical recess, for accommodating the rotors (shut-off part 2 and power part 3).

In order to prevent the inner housing 1 from rotating along, springs 11, which engage recesses 12 at the housing 10, are formed at the outside of the inner housing 1. The recesses 12 are disposed between an inner surface of the housing 10 and the outer surface of the inner housing 1. The recesses 12 and the springs 11 together define first structural and biasing means.

Above the shank of the power part 3, a cone 13 is disposed. The cone 13 defines second structural means for preventing movement of the inner housing 1 away from the control head 5.

The shut-off part 2, the power part 3 and the inner housing 1 are pressed against one another in an axial direction. The extent of the precessing is effected by adjusting rings 14 and a split washer 15. The adjusting rings 14 define second biasing means and the split washer 15 defines third biasing means.

Due to the free displaceability of the inner housing 1 relative to the rotors 2 and 3, manufacturing tolerances of the sub-assembly as a whole, especially of the shut-off part 2 and the power part 3 are averaged. As a result, gap flows are reduced.

The operating pressure of the rotary piston machine in the space between the housing 10 and the inner housing 1 is transferred through openings 16 into the inner housing 1. By these means, an additional force is produced, with which the inner housing 1 is pressed in the radial and axial directions against the shut-off part 2 and the power part 3.

In order to prevent loss of conveying fluid from the housing 10, a mechanical seal 17 is disposed between the flange 9 and the shaft of the motor 8.

All the distinguishing features, given in the specification, the following claims and the drawing, may be essential to the invention individually as well as in any combination.

1. A rotary piston machine including:
first and second rotors each having an outer radius, said rotors being mutually disposed at an axial angle, said first rotor engaging said second rotor for forming a fluid passage, said passage having an opening at said outer radius of said rotors, said second rotor having a shank, said shank engaging a motor shaft;
a housing including an inner surface and including an inner housing, said inner housing comprising:
an outer surface spaced from said inner surface of said housing;
a cylindrical borehole having a spherical recess, said rotors being disposed in said borehole;
a first opening disposed in the spherical recess of said borehole, said shank of said second rotor passing through said first opening for engaging said motor shaft;
said inner housing being shiftable, relative to the rotors in axial and radial directions;
first structural and biasing means for urging said inner housing against rotation within said housing;
second structural means for preventing movement of the inner housing in the axial direction away from the rotors; and
a second opening disposed proximate to said passage opening in said outer radius of said rotors, said second opening being adapted for transferring fluid pressure to said space between the outer surface of the inner housing and the inner surface of the housing for producing contacting pressure between the inner housing and the rotors for minimizing gap flows.

2. The rotary piston machine of claim 1, further comprising:
second biasing means for moving said rotors axially towards said motor; and
third biasing means for limiting movement of said rotors axially towards said motor.

3. The machine of claim 1 wherein said first structural and biasing means comprises:
a recesses disposed between said inner surface of the housing and said outer surface of the inner housing; and
springs disposed on said outer surface of said inner housing, said springs engaging said recess.

4. The machine of claim 1 wherein the second structural means comprises a cone.

5. The machine of claim 2 wherein the second biasing means comprises adjusting rings.

6. The machine of claim 2 wherein the third biasing means comprises a split washer.

7. A rotary piston machine including:
first and second rotors mutually disposed at an axial angle, said first rotor engaging said second rotor for forming a fluid passage, said passage having an opening at an outer radius of said rotors;
an outer housing and an inner housing, said inner housing comprising:
a cylindrical borehole having a recess, said rotors being disposed in said borehole;
a first opening disposed in said borehole recess, said second rotor passing through said first opening; and
a second opening disposed proximate to said passage opening in said outer radius of said rotors for transferring fluid exterior to said inner housing.

8. The machine of claim 7 wherein said inner housing is shiftable, relative to the rotors, in axial and radial directions.

9. The machine of claim 7 wherein said borehole recess is spherical.
